(19) United States
(12) Patent Application Publication
(10) Pub. No.: US 2005/0005419 A1
(43) Pub. Date: Jan. 13, 2005

(54) Machine tool

(76) Inventor: Heinrich Lutz, Dirlewang (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/833,011

(22) Filed: Apr. 28, 2004

(30) Foreign Application Priority Data
Apr. 28, 2003 (DE) 103 19 137.2
Sep. 26, 2003 (DE) 103 45 119.6

(51) Int. Cl. B23P 23/00

(52) U.S. Cl. 29/563; 409/159; 409/134; 409/137; 409/168

(57) ABSTRACT

The invention refers to a machine tool where the work piece is conveyed in the working area of the machine tool by means of a conveying device, and the work piece is clamped in the working position by a clamping device. It is proposed that the conveying device provides the feeding as well as the removal of the work piece to and from the machine tool, and also the conveying of the work piece in the working area.

The invention refers to a machine tool where the work piece is conveyed in the working area of the machine tool by means of a conveying device and the work piece is clamped in the working position by a clamping device.

### BACKGROUND OF THE INVENTION

Machine tools as mentioned before are sufficiently known in the state of the art. They are used, for example, in cutting machining. It is also known to use these machine tools, for example, in a transfer line or in a group of machine tools, which are interlocked with each other. The characteristic of such arrangement is the fact that the respective machine tools are specialised for a particular machining step or a group of machining steps.

The large number of possible machining steps within such a machining line allows complex machining on the work pieces.

It is known to feed the work pieces by special translators from a conveying belt to the machine tools, and to convey them out, after machining, again by the translators. The translator here is designed like a robot, that means comparatively complex. Also the receiving of the work piece by the translator needs a certain time which enlarges the cycle time.

It is an object of the invention to improve a machine tool as described in the beginning in such a way that the cycle times are reduced and thus the machine works more efficiently.

### BRIEF SUMMARY OF THE INVENTION

In order to solve this problem the invention proposes that the conveying device provides the feeding and removing of the work piece to and from the machine tool, in particular to and from adjoining machine tools, as well as for the conveying of the work piece in the working area.

The translator provided in the state of the art is not necessary because the working area of the machine tools according to the invention becomes part of the actual conveying way.

This surprisingly simple solution leads directly to an advantage of speed because the work piece does not need to be positioned at first in the gripping range of the translator and then to be picked up by it and conveyed in the working area, but the invention allows to position the work piece directly and immediately via the same conveying device, which also provides the conveying of the work pieces between the machine tools, in the working area. The invention saves a step in the preparation, respectively supplying, of the work piece which has to be machined on. As conveniently the machine tool according to the invention is integrated, for example, in a flowing concept the finished work piece leaves, for example, at the end side via the conveying device, and simultaneously a new work piece is fed at the entrance side. An expensive change of the work piece by means of a changer is not necessary here, either.

Furthermore the solution according to the invention is also considerably cheaper because the comparatively expensive translator according to the state of the art is saved. Thus the invention reaches a solution of the problem according to the invention and simultaneously machine costs are saved.

The invention is here not restricted in any way to the type of the machine tool. It may be here a “simple machine”, which, for example, operates with one machining spindle and few axes of movement, or, in the same way, a complex machining center with a number machining axes and/or machining spindles.

In an advantageous embodiment of the invention it is provided that the conveying device conveys the work piece, respectively a work piece carrier carrying the work piece, directly in the clamping device. The clamping device here is within the working area. The clamping device fixes the work piece either directly or indirectly via its work piece carrier in the range of the machining spindle with the tool. A considerable increasing of speed is reached if the work piece is conveyed directly in the clamping device and then, immediately after the work piece has been identified, the clamping device positions the work piece and holds it.

Advantageously the working area is sealed by at least one door. The door can move here, for example, horizontally or vertically. The doors may be sliding doors or even swinging doors. Also arrangements are known where several doors are provided through which the work piece has to be conveyed. For example, the work piece is conveyed in through the first door and conveyed out again through the second door.

In a variant according to the invention one or more drive shafts extending parallel to the conveying path are provided for the conveying device. For example, the conveying device is designed as roller conveyor or friction roller conveyor, without the intention of restricting the invention to that. This central drive shaft allows to drive a number of single drive rollers centrally. Only a small number of drive motors for this drive lane is necessary. Conveniently a drive motor drives a drive shaft which, for example, extends over several machine tools according to the invention. The drive shaft therefore provides regions of the conveying device within as well as outside the machine tool.

In a preferred embodiment of the invention it is provided that the drive shaft is outside the door, respectively outside the region which is covered by the opening door.

Such an arrangement leads, for example, to the arrangement of the drive wheel as it is shown in the drawing, the support point of the work piece carrier or the pallet on the drive wheel being arranged below the axis of the drive shaft in a clear distance.

In another arrangement according to the invention it is suggested that a common drive is provided for the clamping device and for a conveying separating device, the conveying separating device preventing the conveying device from conveying the work piece during clamping of the work piece and making it possible that the clamping device clamps the work piece.

In the state of the art it is known, for example, to convey work pieces, which have to be machined on, in a machine tool group with two machining units opposing each other. The clamping device is here received on a pallet. The pallet is then conveyed by means of a circular table carrier in the machining station between the two machining units. These devices are very expensive and need in particular various drives for the clamping device and for the circular table carrier. Furthermore a separate drive also for conveying the work piece after machining, respectively before machining, is necessary. Altogether such a solution is very expensive, and it is carried out considerably more convenient by means of the suggestion according to the invention to provide a common drive for the clamping device and for a conveying separating device. The effort compared with the solution described before is considerably smaller. In addition to that, during the machining, respectively the clamping procedure, significant time is saved which makes a considerably larger throughput of work pieces through the machine unit possible.

In the state of the art also a solution is known where the work piece has to be clamped on a device carriage for machining in the working area. This device carriage then runs on the conveying line and the work piece is conveyed through the machining plant on the device carriage. The construction effort for positioning the work piece for the respective machining, respectively for moving the work piece simultaneously during machining by the machining spindles, is considerable. Also such a construction effort is reduced significantly by the suggestion according to the invention to provide now a common drive for the clamping device and a conveying separating device.

In the state of the art where the pallet with the work piece was conveyed in the working area through the translator, nothing had to be provided in order to disengage the conveying device. The actual conveying device, the work piece belt, passed the translator on the side. On the other side, of course, a drive is provided for the clamping device. According to the invention it is now cleverly proposed to use this already existing drive for the clamping device also for a conveying separating device which provides that the conveying device is disengaged from the work piece, respectively its pallet, and that means during the period of time when the work piece is clamped, respectively also machined. The invention determines in no way the type of drive and the deduction of the drive for the clamping device and the conveying separating device. For example, simply mechanic, but even electric or electromechanic, hydraulic or pneumatic means may be provided for that purpose. The advantage of this embodiment is in particular that no additional drive has to be provided for the conveying separating device, respectively the door, although naturally also in the frame of the invention an arrangement is protected where drive is provided for the clamping device, as well as one for the conveying separating device, respectively the door.

In the frame of the invention a work piece, respectively a work piece carrier carrying a work piece, is mentioned frequently. It has to be considered that, as far as a use or functionality is described only with regard to the work piece, this goes in the same way also as described for the work piece carrier, even if it is not mentioned expressly. Prefabricated pallets serve here as work piece carriers, as they are sufficiently known for the conveying on corresponding machine tools.

In another variant the invention provides that, after the work piece has been conveyed in the working area, first of all the drive acts on the conveying separating device and after that the drive acts on the clamping device. This sequence is advantageous because, first of all, as soon as the work piece has reached the desired position within the working area, the further conveying of the work piece is prevented by activating the conveying separating device by means of the drive. The work piece, thus already roughly positioned—for that purpose for example a stopper or the like is provided in the conveying path—is clamped after that by the clamping device and the drive then acts on the clamping device.

However, in the sense of the invention it is also possible that, while the clamping device clamps the work piece, respectively the work piece carrier carrying the work piece, the conveying device does not move the work piece. In this embodiment according to the invention it is not necessarily needed that a conveying separating device is provided. The conveying separating device causes eventually that the work piece is no more conveyed in the conveying device. In order to keep the work piece in the desired position, however, it is possible in the sense of the invention that the conveying device is simply turned off in the region of the clamping area. This may be carried out, for example, by accordingly separated conveying blocks. Another possibility is to hold the work piece, for example, by a stopper in the path, but not to stop the conveying device because of it. Friction rollers or couplings then disengage the conveying device (for example the roller conveyor) from the drive. For clamping the work piece therefore the work piece does not move.

Cleverly for that purpose a preferably mechanically designed forced control of the drive of the conveying separating device and the clamping device is used. Such a forced control leads to a considerable saving of cycle time, as the respective steps of the conveying separating device and the clamping device can be synchronised to each other optimally. It is possible here to realise such a forced control depending on the type of drive (see above) in the simplest way. It is, for example, possible to turn on or off the clamping device in a pneumatic or hydraulic drive by means of suitable opening or closing control openings at suitable times.

However, the invention also presents special advantages in the design of a mechanically designed forced control, as it can be manufactured cheaply and realised and adjusted simply.

In a preferred variant of the invention it is provided that the top edge of the door is arranged slightly above the top edge of the work piece, respectively a work piece carrier carrying the work piece. The drive shaft which drives the conveying unit is lead here in the region of the machine housing which is not formed by the door. The door opening is here just big enough to allow the work piece to be conveyed in and out. This makes the design of the door drive easier as it has, if the door is dimensioned too largely, to be, under circumstances, dimensioned larger or faster in order to open the machine door in a corresponding period of time, because it cannot be opened before the machining has been finished. The times for opening, respectively closing, the door eventually determine the efficiency, respectively the capacity, of the machine tool according to the invention.

It is, in particular, an advantage if it is provided that the common drive which is provided for the conveying separating device and/or for the clamping device also drives the door. On the one hand, drives are saved by that. On the other hand, it is, by means of a clever mechanical arrangement, in a simple way possible to co-ordinate the chronological sequence of door opening, respectively closing, clamping and, if necessary disengaging, of the conveying unit.

Therefore it is an advantage if the door drive is carried out, for example, by forced control, in particular in the drive of the conveying separating device, respectively clamping device.

For example, for doors designed as sliding doors pulleys are provided on the shaft driven by the drive, the toothed belts of which move the sliding doors.

In a preferred embodiment of the invention it is provided that both the clamping device and the conveying separating device have a control rod on which acts a shaft driven by the drive. Coming from the arrangement in the prior art where such an arrangement has already been used for the clamping device, now an arrangement for control of the conveying separating device is added. Conveniently a similar construction is chosen here. Cleverly the control rods are arranged on the same shaft driven by the drive.

For the door drive cleverly a pulley is used on this common shaft.

In another variant of the invention it is provided that the shaft acts in different angle positions on the control rod of the conveying separating device, respectively clamping device. By means of that in a very simple mechanic construction a forced control can be realised for the conveying separating device, respectively the clamping device. The angle positions of the connecting rod for the conveying separating device, respectively the clamping device, are chosen here especially in such a way that the respective actions are finished or are carried out simultaneously, however, do not disturb each other, therefore, for example the conveying is turned of and the clamping of the work piece is carried out after that.

In a first variant according to the invention it is provided that cams are arranged on the shaft, and the cams act on the control rods. Here the cams have a different angle position, resulting in various movements of the control rods along the rotation of the shaft.

In another variant according to the invention it is, for example, provided that the control rod has a connecting rod, and on the shaft a crank pin is arranged eccentrically which is connected with the connecting rod. This arrangement of a rod assembly for transposition of a rotational movement into a linear movement may also be known sufficiently, however, especially in this range of use according to the invention it presents advantages because of its high reliability and simple construction. Here also the different angle positions are achieved by means of a different arrangement of the eccentric crank pins.

According to the invention it is possible that the work piece with or without work piece carrier is conveyed by the conveying unit. Eventually this depends on the particular field of use of the machine tool whether it is more convenient to use a work piece carrier (or pallet), or to convey the work piece directly.

It has turned out to be convenient that the conveying unit is designed as roller conveyor. Such a roller conveyor or roller belt, if necessary also called friction roller conveyor, is quite common as means for conveying in the machine tools mentioned above. Especially friction roller conveyors allow also an accumulating conveying because the friction simply does not drive the correspondingly blocked wheel because the friction is too large. Therefore it is, in the sense of the invention, also possible to use, instead of the roller belt as conveying device, even any other conveying devices. These may be, for example, conveying belts.

According to the invention the rotational axis of the roller conveyor is orientated horizontally, vertically and/or diagonally. There are various concepts how to drive the work piece carrier, respectively the work piece, by means of the conveyor roller belt. Support surfaces which are orientated diagonally lead here, if necessary, to rotational axes which are orientated diagonally, or to drive rollers like truncated cones which rotate around rotational axes which are orientated horizontally and/or vertically. The diagonal arrangement of the running treads, respectively support surfaces of the work piece carriers, however, result in an autonomous guide of the work pieces on the line and thus reduce the risk of an undesired jamming of the work pieces in the chain of machining.

In another variant of the invention it is provided that the work piece, respectively the work piece carrier carrying the work piece, is supported and can be driven laterally by a row of rollers as conveying device, and that the rollers in the first row have a shaft independent from the rollers of the second row.

Conveniently the work piece, respectively the pallet, which has to be conveyed, is located between the two rows of rollers. The arrangement here allows that the work piece is conveyed standing or suspended. According to the invention the wok piece may be conveyed mounted on a pallet or without pallet. The use of a work piece carrier/pallet has the advantage that, independent of the width of the work piece, always standardised distances between the rows of rollers can be applied and thus a conveying is possible without any problems even with different widths of work pieces.

The invention also allows to machine, respectively convey, the work piece standing or suspended. In particular the suspended machining presents advantages, for example, during a dry machining as the chips can fall downward without any problems and are not deposited on the work piece or the work piece carrier and can be carried over. Especially in a suspended machining it is an advantage that the space between the rows of rollers is free. Such an arrangement is, for example, shown also in the drawing. The invention, however, can also be used in the same way in an arrangement where the work piece is supported standing on a roller conveyor. The invention can also be used in an arrangement where the rollers support not only the work piece, respectively the work piece carrier, laterally, but over the complete width of the work piece, that means the roller is guided laterally by two cheeks.

In another embodiment of the invention it is advantageously provided that the conveying separating device is designed with regard to the work piece as lowering device, respectively lifting device. The conveying separating device achieves that the conveying device will not engage anymore with the work piece, respectively the work piece carrier, for conveying purposes. Conveniently here the relative movement of the work piece, on the one hand, and of the conveying device, on the other hand, is carried out.

According to the invention it is possible here, to lift, for example the work piece, respectively the work piece carrier, slightly by means of the conveying separating device and thus prevent conveying. For example, corresponding pins occur between the rollers of the conveying device and lift the work piece/pallet slightly.

In another variant of the invention it is, for example, possible that the conveying device is lowered a bit and the work piece, for example, is lowered on corresponding supports. In this case the conveying separating device acts as lowering device.

In a preferred embodiment of the invention it is suggested that the control rod of the conveying separating device disengages the conveying device from the work piece, respectively the work piece carrier carrying the work piece. In this case the conveying separating device acts as lowering device for the work piece. Such an arrangement is achieved by the fact that the conveying unit in the working area is at least designed partly in such a way that it can be moved, in particular turned, away from the conveying plane conveying the work piece. Conveniently the conveying unit is supported flexibly and can therefore be turned away in an easy way. The control rod of the conveying unit acts here on the part of the conveying unit and pushes it so far downwards until the conveying unit does not act anymore on the work piece. In this case then the work piece, respectively the work piece carrier, is supported on a support.

Alternatively it is possible that the conveying unit can also be moved away linear, for example is lowered a bit. This also leads to the fact that the conveying unit is disengaged from the work piece. The work piece, respectively the pallet, then is supported by the corresponding support in the same way.

In a preferred embodiment of the invention it is provided that in the working area at least a part of the rollers of the conveying device is supported swivelling around an axis, and the control rod of the conveying separating device acts in such a way on the roller against the force of a restoring spring that the roller is disengaged from the work piece, respectively the work piece carrier carrying the work piece. The restoring spring provides that, when the control rod does not act anymore on the conveying device, the lowered part of the conveying device returns again to the conveying plane and the conveying device is engaged for conveying the work piece, respectively the pallet.

According to the invention it is also provided that the control rod of the conveying separating device acts, guided by force, in such a way on the rollers that the control rod provides that the roller is disengaged from the work piece/work piece carrier, as well as provides that the roller engages again with the work piece/work piece carrier. Such an arrangement is in particular advantageous when the conveying rollers have to carry a considerable weight which would have to be compensated by a restoring spring. The arrangement with a restoring spring is convenient, for example, when the pallet is used standing.

Alternatively it is suggested according to the invention that the rollers of the conveying belt in the working area can move axially so that during clamping of the work piece, respectively the work piece carrier carrying the work piece, the rollers are able to follow the clamping movement of the work piece, respectively the work piece carrier.

Frequently the work piece, respectively the work piece carrier, is moved during clamping rectangular to the direction of conveying of the work piece, respectively the work piece carrier, in the conveying device. It is possible here that the rollers of the conveying belt are disturbing. First of all the conveying device is disengaged from the work piece by means of the conveying separating device, as described above, so that it cannot disturb anymore during clamping. In the other variant presented now the rollers (for example friction rollers) remain in contact with the work piece/work piece carrier, however, follow the clamping movement.

There are again several variants for that. First of all it is possible that the shaft which carries the conveying wheel, can move axially. For example, the roller shaft is guided axially in a liner. The movement here is carried out, for example, against a restoring spring or is guided by force. In the other alternative embodiment the shaft is axially stationary, however, the roller turning on the shaft has a certain axial movability in order to follow thus the clamping movement.

Conveniently the invention provides that the clamping device has a support surface where the work piece, respectively the work piece carrier carrying the work piece, is supported in the working area as soon as the conveying device is not engaged anymore. This arrangement is convenient in so far as no other support surface is necessary. The arrangement also saves time as the clamping device is supposed to clamp the work piece after that. Therefore another transferring or approaching of the clamping device is not necessary anymore.

In a preferred embodiment of the invention it is provided that the clamping device has at least one clamping iron, and the clamping iron clamps the work piece against, in particular stationary, clamping cones. Here the clamping cones serve in particular for an exact positioning, respectively indexing, of the work piece, respectively the work piece carrier.

Conveniently the clamping device has a clamping surface against which the work piece, respectively the work piece carrier carrying the work piece, is clamped by a clamping iron. This clamping surface is correspondingly exactly positioned as it influences directly the result of the machining of the machine tool. The control rod of the clamping device acts here directly or indirectly, for example via a clamping crosshead.

If the clamping surface serves as an exact stopper, respectively reference surface, a movement in this clamping surface still remains which conveniently is compensated by an indexing during clamping. The work piece is exactly positioned during clamping by that.

Alternatively it is provided according to the invention that the clamping device has one or more movable clamping cones which engage with recesses of the work piece interacting with the clamping cone or of the work piece carrier carrying the work piece and, clamp it against a support. The cone may be designed here as inner or outer cone.

Therefore two variants are available for clamping for which two alternatives are suggested here. First of all the work piece/work piece carrier is clamped by a clamping iron on a cone. The clamping iron here is the movable element which exercises the clamping power. In the other variant the clamping cone is designed movable which engages in an interacting recess of the work piece, respectively the work piece carrier, and thus achieves the clamping. According to that the clamping cone nay be designed as inner or outer cone and the recess may interact with it accordingly. The cone here imprints the clamping power.

According to the invention it is possible here that the clamping movement of the work piece, respectively of the work piece carrier carrying the work piece, by the clamping device is carried out vertically, horizontally or diagonally, depending from the machining which has to be carried out. Eventually the clamping direction follows the machining task. If, for example, the bottom side of the work piece has to be machined on, it may be advantageous to machine the work piece on a standing pallet. In order to clamp the pallet optimally a horizontal clamping movement may be an advantage. However, if a side of the work piece has to be machined on, it is possible to machine on the work piece suspended in the pallet or standing on the pallet, the work piece carrier/pallet being orientated horizontally, conveniently a clamping is carried out in vertical direction. Of course, it is even an advantage with angled machinings to provide, if necessary, a clamping direction orientated diagonally in the space. The invention is not restricted in this regard.

Conveniently the drive for the clamping device and the conveying separating device has a gear. The gear serves, on the one hand, for adjusting the rotation relation and, on the other hand, also for providing a sufficient turning moment. On the one hand, the control rod of the conveying separating device has to be moved against the force of the restoring spring or the weight of the work piece, on the other hand, the complete load of the work piece is on the clamping device during machining. As both actions need a high turning moment, however, these turning moments are not demanded simultaneously, but one after the other, corresponding synergy effects follow from the concept of the arrangement of the drive according to the invention for the clamping device and the conveying separating device as common drive. The high turning moment which is present anyway is used again at another time.

The use of a gear makes the adaptation of the motor, which is designed in any way, for the respective load problem possible.

Advantageously it is provided that the drive has two drive shafts and the drive is arranged between the rows of rollers. The drive shafts here extend to each of the rows of rollers. The control rods for the clamping device and the conveying separating device then have contact to the drive shafts which act in this case as shafts, as described above.

It is provided that the drive is designed as rotating field magnet, servo-motor or gear motor. This arrangement refers to an electromechanic principle and can be combined, naturally, in any way with a gear. Alternatively, however, it is also possible that the drive is designed hydraulically or pneumatically. Especially arrangements with hydraulic allow the transmission of larger forces. It is in the same way possible here to let an hydraulic or pneumatic drive act on a drive shaft, as described above. Alternatively it is, of course, also possible to do without the arrangement of the shafts and to achieve similar forced controls by means of suitably controlled working cylinders, if necessary, in knuckle joint construction.

Furthermore it is, according to the invention, proposed that air or cleaning liquid jets are provided for the running treads of the rollers and/or clamping cones. According to the invention it is provided that the running treads of the rollers are designed for example diagonally, in particular V-shaped. In this groove-like running wheels it is possible that chips are whirled up which then disturb the conveying of the work piece carrier. This is prevented by means of the air jets or cleaning liquid jets. As cleaning liquid, for example, cooling liquid or other liquid lubricants, usually with machine tools, are used as it is known for cleaning and lubricating in cutting machinings. Conveniently here not only the running treads of the rollers but, if necessary, even the clamping cones are kept clean from chips accordingly.

According to the invention it is provided that the machine tool is designed as cutting, forming, assembling or separating machine or the machine tool is designed as testing, mounting, adjusting, surface treatment, identifying or as cleaning station. The machine tool according to the invention is in no way determined to the machining which takes place in it. All possibilities of machinings mentioned before necessitate a positioning of the work piece. Basically the positioning of the work piece should be carried out as time-optimised and exactly as possible, which is, independent from the actual machining, solved by the invention. Therefore the invention can be used for very different purposes of a machine tool. On the one hand, it is possible that the machine tool actually machines on the work piece, that means cuts, forms, assembles or separates. In addition to that, however, it is also an advantage that the machine tool is designed as testing station in order to check corresponding machinings of a previous machine tool. It is an advantage here to provide suitable tests as early as possible in order to avoid the recognition of a fault in an early machining in the final inspection after a number of machinings, and the complete work piece is waste. It is also possible to design the machine tool as mounting station. For example, it is possible to cut a thread in a boring which has been provided before, and then to mount in this thread another component in the mounting station. However, it is also possible to carry out, for example, a work piece change in a mounting station that means for example to mount another work piece carrier.

In the same way it is convenient to provide the mounting station for an exact positioning, respectively orientation, of the work piece. Furthermore it is possible that the machine tool is designed as surface treatment station. This serves, for example, for lacquering, electroplating, printing and so on.

Furthermore as machine tool also an installation for identification of work pieces may be provided. In an identification station it is provided that, for example, labels or other identifications, if necessary also electronically readable identifications like bar codes or transponders, are fastened or attached to the work piece, respectively its work piece carriers, in order to identify the respective work piece for the control. As a rule here a corresponding identification step precedes that (although not compulsory).

It is also convenient here that as machine tool a cleaning station, respectively rinsing or washing station, is provided. Frequently the work pieces are soiled during the machining, for example by lubricants, which has to be washed off especially at the end of a process line. Neither is it convenient if correspondingly oily emulsions remain on the work pieces when, after that, a surface treatment, like a lacquering or other coating should be carried out.

The machine tools mentioned before should be designed as automatically working systems or as manual working stations in the sense of the invention.

### BRIEF DESCRIPTION OF THE SEVERAL VIEWS OF THE DRAWINGS

In the drawing the invention is shown schematically. In the drawing:

FIG. 1 a view of the machine tool according to the invention;

FIG. 2 a side view of the machine tool according to the invention;

FIG. 3 a view of another variant of the invention;

FIGS. 4 and 5 further details of the invention;

FIGS. 6, 7 and 8 further variants of the invention each in a view and

FIG. 9 a detail of the invention according to FIG. 8 (see detail IX).

### DETAILED DESCRIPTION OF THE PREFERRED EMBODIMENT

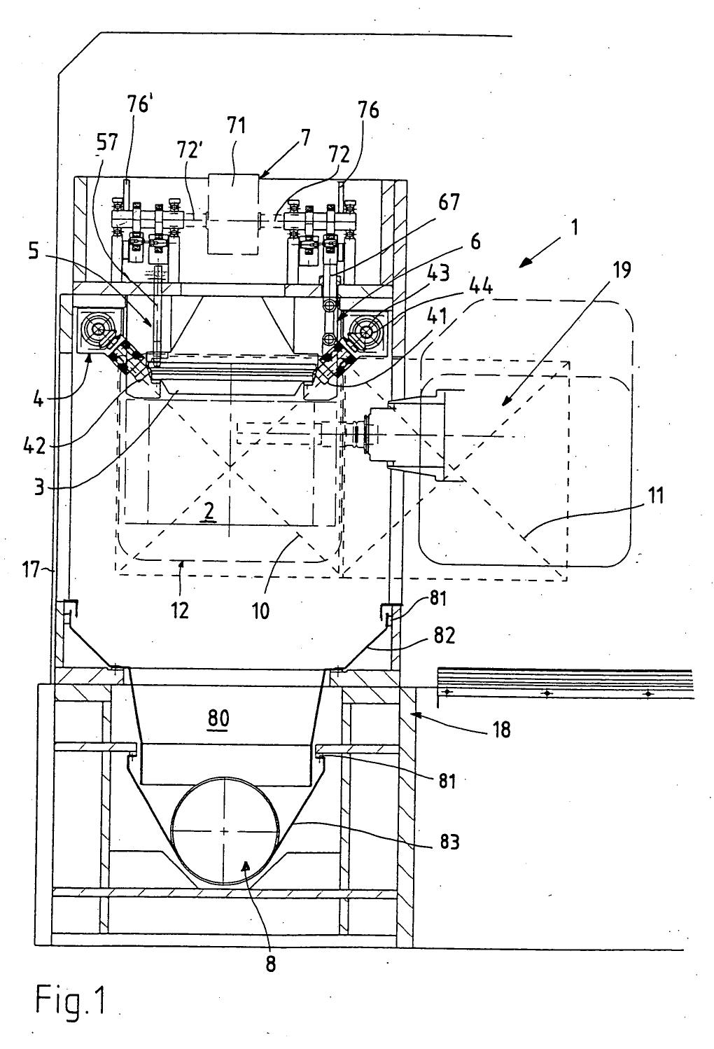

In FIG. 1 the machine tool according to the invention is shown schematically. The machine tool 1 here comprises a machine frame 18 which holds in the bottom region the chip collector 80, respectively the chip conveyor 8. The machine frame 18 is connected with the machine housing 17 on the top side. The machine housing 17 encloses the actual working area 16.

The machine housing 17 has several openings 12 which can be sealed by a door 10. The door 10 is indicated in FIG. 1 with short dashed lines, the openings 12 in longer dashed lines. The door 10 is shown in a position which seals the openings 12 as well as in a position which releases the openings 12. For that purpose the door 10 is shifted to the right hand side. The door 10 is designed in this case as sliding door, the range which is covered by the moving door is indicated with 11.

For the door drive a pulley 76, 76′ is provided on the drive shaft 72, 72′ which move the doors via a toothed belt not shown. The arrangement here is chosen in such a way that the diameter of the pulleys as well as the rotation of the shaft 72, 72′ are enough to open the door 10 completely in order to achieve a collision-free feeding and removing of the work piece 2.

A spindle 19 is provided for machining the work piece 2.

In the example shown here the work piece 2 is suspended on a work piece carrier 3. This suspended machining has in particular advantages for the chips to be removed as these can fall downwards unimpeded in the funnel-shaped chip collector. Basically such an arrangement allows a dry machining, the arrangement, however, can also be used for wet machining.

For the conveying of the work piece 2, respectively the work piece carrier 3 carrying the work piece 2, respectively the pallet, a conveying device 4 is provided. In the example shown here the conveying device 4 is formed by two rows 41, 42 of rollers extending parallel. The rotational axes of the rollers 40 form a sharp angle with the horizontal line, preferably an angle of 45°. In this case the work piece carrier 3 is supported with corresponding guide rails on the rollers 40 in such a way that the work piece carrier 3 partly projects over the rollers 40 upwards, however, the work piece 2 extends completely below the rollers 40.

The angled arrangement of the rotational axes of the rollers 40 leads also to the situation that the rollers of the first and second row of rollers are not to be arranged on a common shaft. This is not provided, either, in this embodiment (however, without excluding this in general), as the work piece 2 is conveyed between the rows 41 and 42 of rollers.

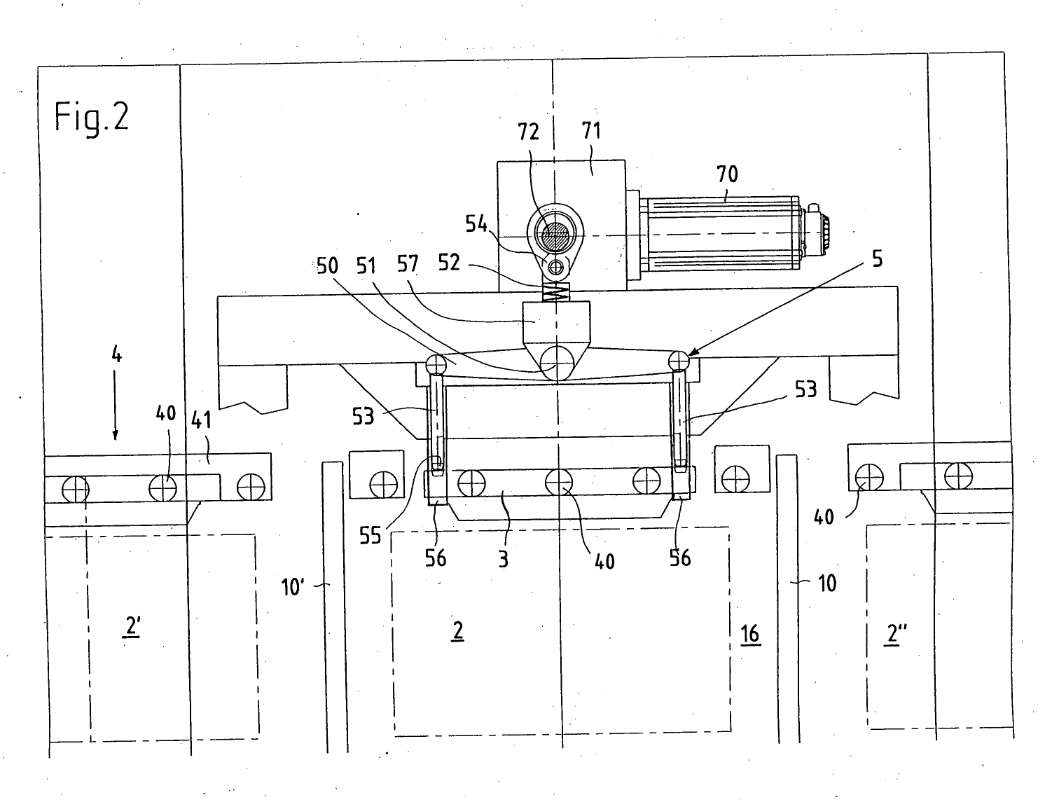

Because of the angled arrangement of the rotational axis of the rollers 40 their drive shaft 43 is located above the roller 40. The drive shaft 43 here supplies a number rollers 40 arranged one behind the other as it is, for example, indicated in FIG. 2. They may be designed, for example, as friction rollers. The advantage of such an arrangement is the fact that with a small number of drive motors a large number of drive rollers on the respective rows 41, 42 of rollers can be driven. If necessary, only even one drive is provided for the two rows 41, 42 of rollers. In this case a suitable gear is arranged.

The arrangement of the drive 43 above the rollers 40 is also clever because the drive shaft 43 thus does not project in the region 11 of the opening door 10 and collides with it. Therefore the arrangement saves space. Furthermore this arrangement is also space-saving even in the working area itself as the drive shaft 43 in the working area is arranged further up and thus further away from the spindle 19. The position possibility of the spindle 19 is accordingly increased. The drive shaft 43 extends here parallel to the conveying unit 4 along the conveying path.

Besides the clever arrangement of the drive shaft 43 above the door 10, respectively its range 11, it can be seen clearly in the drawing that the top edge of the door 10 is arranged slightly above the top edge of the work piece carrier 3 carrying the work piece 2. Therefore it is guaranteed that the work piece carrier is conveyed in and out without collision out of the working area through the opening 12. This goes, naturally, also for the case when the work piece 2 is conveyed without a work piece carrier 3.

For an accurate machining of the work piece 2 in the working area 16 it is provided that the work piece 2 is clamped on exactly known points (so-called index points). By means of that the work piece is exactly determined in the space and the control of the spindle 19 can carry out the desired machinings on the desired point.

The clamping device 5 is activated by a drive 7. The drive 7 (see FIG. 2) comprises here, for example, a motor 70 and a gear 71 connected to it. The gear 71 is located above the work piece 2 and therefore in a range between the two rows 41, 42 of rollers.

The clamping device 5 clamps and positions the work piece carrier 3 on exactly four points, namely preferably on the respective corners of the work piece carrier 3. Therefore the arrangement is here preferably, with regard to the center plane (defined between the two rows 41, 42 of rollers), provided as symmetric construction of the clamping device.

The clamping device comprises here at least two clamping dies 53 (or also clamping cones) which clamp the pallet during clamping downward against stationary clamping surfaces 56. Alternatively it is possible that clamping irons are provided which clamp the pallet during clamping upward against corresponding clamping surfaces. Simultaneously also an indexing is carried out, and thus an exact determination of the work piece carrier in the space. The clamping dies 53 are here eventually operated by control rods 57 which are supported and guided eccentrically on the shaft, respectively the drive shaft 72, 72′. The gear 71 drives the drive shaft/shaft 72, 72′. Because of the symmetric construction a shaft/drive shaft 72 extends on the right hand side and a shaft/drive shaft 72′ on the left hand side of the gear 71.

Conveniently the shafts 72, 72′ still are supported multiple.

It is an advantage here that the drive 7 is used also simultaneously for the conveying separating device 6 and/or the opening, respectively closing, movement of the door 10. The conveying separating device 6 provides that the conveying device 4 does not try to convey the work piece while it is clamped. For that purpose a control rod 67 acting on parts of the conveying device 4 is provided similar as for the control for the clamping device 5.

In the example shown here the roller 40 can turn around the axis 44. The movement (vertical here) of the control rod 67 leads here to a turning away of the respective connected rollers 40 to the outside (with regard to the work piece 2).

Here the mechanism is not provided for all rollers 40 of the conveying unit 4 but preferably only in the region where the work piece has also to be clamped by the clamping device 5.

In FIG. 2 it is, for example, shown that three rollers 40 are designed in such a way that they can be turned away in the center region, the other rollers 40 do not have this option.

By means of the chance that the rollers 40 can be turned away it is achieved that the pallet 3, respectively the work piece 2, is lowered relatively downward and is deposited on stationary support surfaces.

Conveniently the flexibly supported rollers 40 are guided by force through the control rod 67. This means they are by means of the control rod 67 not only brought downward, that means disengaged from the work piece carrier, but also by force engaged again upward with it. Instead of this forced guide it is, of course, also possible that a restoring spring is provided and the control rod 67 presses the conveying unit 4 against the force of this restoring spring.

The selecting of the control rod 67 is here done in the same way as for the control rod 57 of the clamping device 5. The control rod 67 is here also arranged on a eccentrically arranged crank pin of the drive shaft 72, 72′. Here also the arrangement is symmetric with regard to the center plane in order to disengage both rows 41, 42 of rollers.

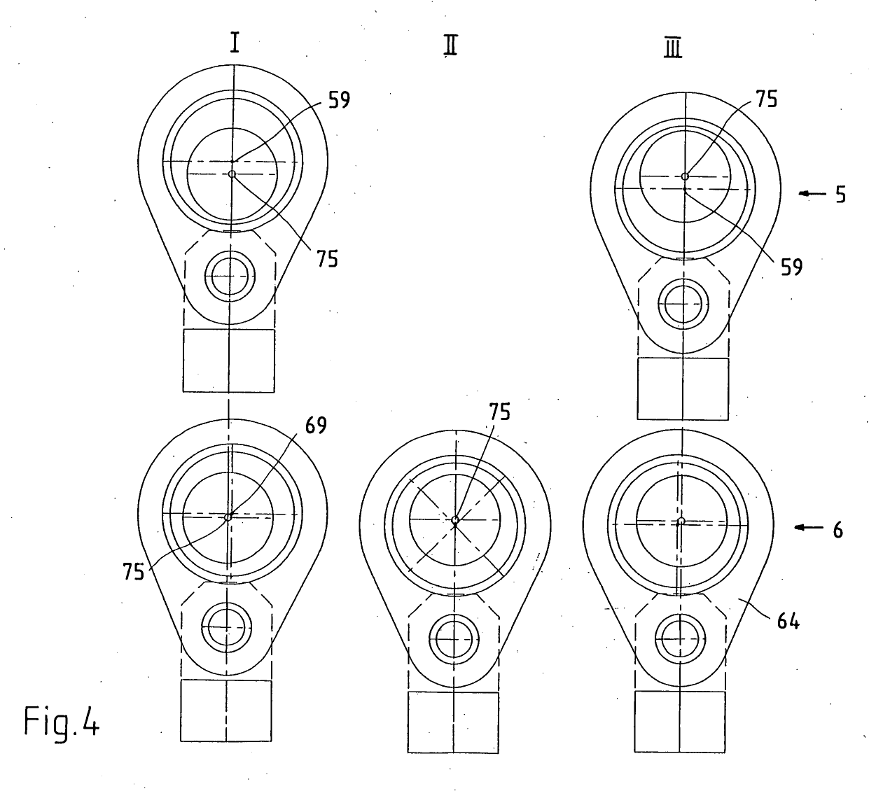

The invention allows here to provide in a simple manner even a forced guide of the movement of the clamping device 5 and the conveying separating device 6 by using the angle position of the selecting of the respective control rods 57, 67 on the shafts 72, 72′. This is shown in particular in FIG. 4.

In the bottom region of the machine tool, in the machine bed or machine frame 18 the chip conveyor 8 is provided. Between the machine tools 1 (for example in a machine line formed by the machine tools 1 according to the invention) pipes or even channels are provided with a rectangular cross section which can be connected to each other via suitable flanges. In the region of the machine tool below the working area 16 a chip collector 80 is provided. It is formed preferably like a funnel and comprises various parts. The first funnel part 82 is pulled up in the working area 16. On the top edge there are corner rails in order to guarantee a secure removal of the chips downward. The machine frame 18 here has suitable recesses through which the first funnel part 82 is guided downward. In the bottom region the second funnel part 83 is provided. Here also the arrangement is selected in such a way that the first funnel part 82 projects in the second funnel part 83 and overlaps in order to secure a safe removal of the chips. The second, bottom funnel part 83 changes into the pipe line of the chip conveyor 8.

The advantage of the multiple-part design of the chip collector 80 is the fact that the assembly is clearly made easier. The smaller funnel parts 82, 83 can here mounted into the machine one after the other and can be put into the machine through openings provided in the machine housing.

Preferably these funnel parts 82, 83 are fastened by rubber bearings 81 to the machine frame 18, respectively the machine housing. The rubber bearings allow a certain flexibility in the orientation of the funnel parts 82, 83 during mounting.

In FIG. 2 the machine tool according to the invention is shown in a side view. In this view only the first row 41 of rollers can be seen where a number of rollers 40 are arranged. In order not to disturb the clear view too much the drive shaft 43 for the row of rollers is not shown, either.

In the working area 16 of the machine tool 1 is limited by the machine housing 17, in particular the doors 10, 10′. The arrangement of the machine tool is chosen in such a way that the work pieces can be conveyed through the machine tool 1. For example, the work piece 2″ has already been removed, the work piece 2 is in the working area for machining and the work piece 2′ is in waiting position in front of the machine tool.

For optimal clamping the clamping device 5 is provided. An exact clamping is compulsory for an exact machining. In the following in particular the clamping device 5 is illustrated in further detail.

The drive 7, comprising motor 70 and gear 71, drives the drive shaft/shaft 72. A connecting rod 54 is supported eccentrically on it which transfers the rotational movement of the shaft 72 into a transversal movement, the procedure of which is actually known. The connecting rod is here arranged, also in a known way, on an eccentrically arranged crank pin. Below the connecting rod 54 a spring assembly 52 is located for a compensation of the clamping forces. The control rod 57 eventually transmits the clamping movement to the clamping die 53 and leads it downward in a conical liner in the work piece carrier. The clamping dies 53 center the work piece carrier in conical liners and press them downward against stationary supports, which embrace for example the edge of the work piece carrier 3. For that purpose the front end of the die 53 serves as index 55. The indexes 55 here center the work piece carrier 3 in conical liners and press them downward against fixed embraces or supports, respectively clamping surfaces 56.

A clamping crosshead 50 is located on the control rod 57, the crosshead carrying on its respective ends the C-like encompassing devices with the clamping surfaces 56. The crosshead 50 can be inclined here around the joint 51 in order to achieve an optimal adjustment of the clamping movement to the clamping procedures. The clamping crosshead 50 can tilt slightly around the horizontal axis.

Alternatively it is provided that the clamping irons encompass the outer edge of the work piece carrier/pallet and draw it, according to the movement guided vertically upward of the control rod, upwards, pushing the pallet on the indexes.

The invention allows a clamping in upward direction, for example with clamping irons, or in downward direction with clamping dies.

The arrangement of the crosshead 50 is here on both side walls of the work piece carrier 3, arranged essentially parallel to the work piece, respectively the conveying path.

Preferably it is mirror-inverted with regard to the center plane between the two rows 41, 42 of rollers.

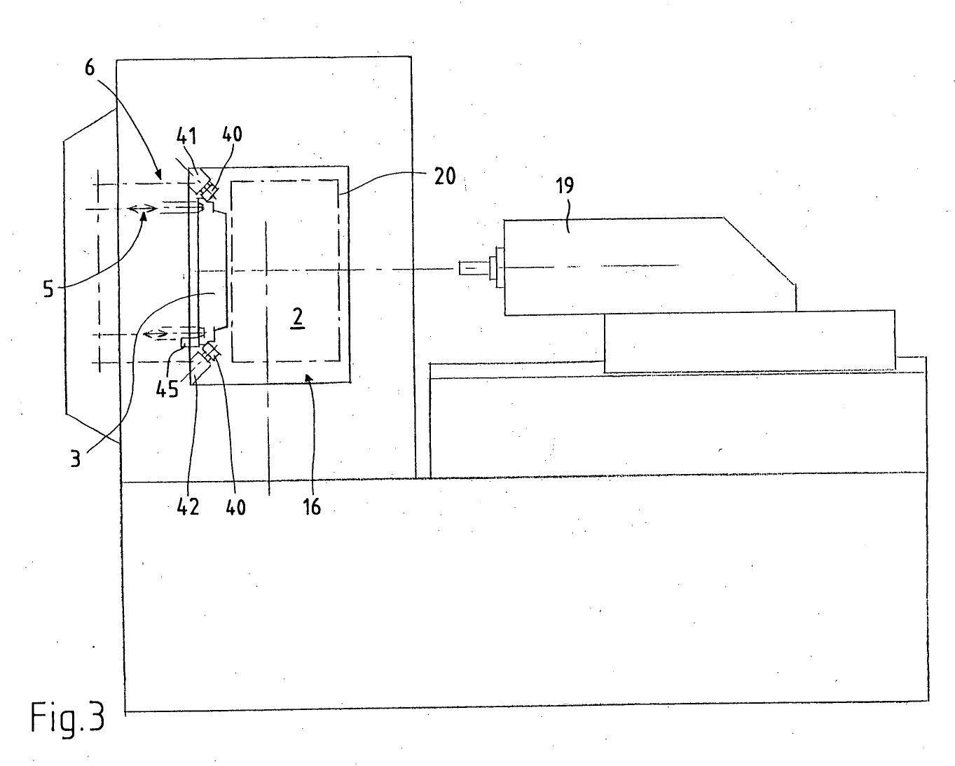

In FIGS. 1 and 2 the work piece carrier 3 is used in horizontal position with the work piece arranged suspended below it. In FIG. 3 an upright machining of the pallet 3 is shown. For a machining of the bottom side 20 of the work piece 2 such an arrangement is convenient. The other four sides of the work piece can be reached by a corresponding re-clamping of the work piece 2 on the work piece carrier. Alternatively it is possible that the work piece, respectively the work piece carrier, is rotated between the machining stations.

The drive shaft 43 may not be shown in this figure, however, there are again advantages here in the arrangement of the drive shaft as proposed according to the invention, because it is put as far back as possible in the working area and thus does not disturb in the working area (16).

For the conveying separating device 6 a forced guide for the selected rollers 40 is provided or a restoring spring against which the control rod acts accordingly and which causes a restoring of the respective conveyor rollers when the control rod is drawn back accordingly. The invention can be used for both arrangements.

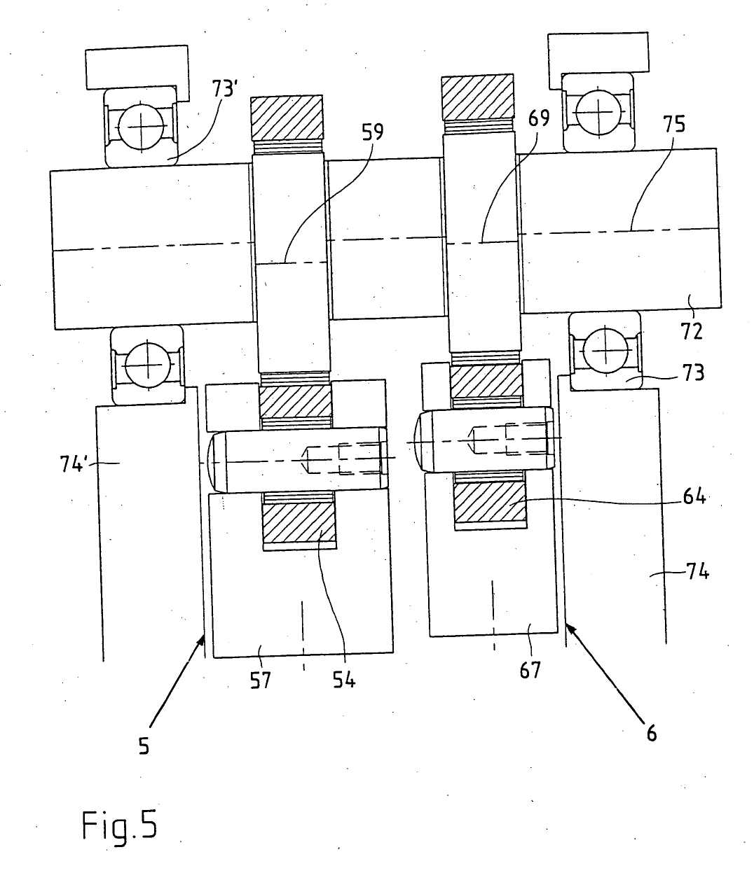

In FIG. 5 an enlarged part of the drive 7 is shown. The turning moment created by the drive 7 is deduced via the drive shaft 72. The clamping device 5 is arranged between the two bearing blocks 74, 74′ on the left hand side, on the right hand side next to it the conveying separating device 6 is provided. The bearing blocks 74, 74′ bear the supports 73, 73′ of the drive shaft 72.

The shaft 72 has eccentrically arranged crank pins which drive the respective connecting rods 54, 64 of the clamping device 5, respectively the conveying device 6. The control rods 57, 67 are connected with the connecting rod 54, 64 via suitable hinge bolts.

The angle position of the crank pins of the clamping device 5 and the conveying separating device 6 are planned cleverly in such a way that the control rod 67 of the conveying separating device 6 first of all lifts the rollers 40 of the conveying unit 4 off the work piece 2, respectively the work piece carrier 3 carrying the work piece 2, deposits the work piece 2, respectively the work piece carrier 3 carrying the work piece 2, on the support surface of the clamping device 5 and, after that, the control rod 57 of the clamping device 5 causes a clamping of the work piece 2 to a clamping surface.

The different angle positions of the clamping device 5 and the conveying separating device 6 are shown schematically in FIG. 4.

In the top row the positions of the clamping device 5 are shown. In the bottom row three views of the positions of the conveying separating device 6 are shown. In the position I the pallet is not clamped, and the conveying separating device not yet active. The axle of the drive shaft 72 is indicated with the reference number 75. The respective rotational axes of the connecting rods 54 and 64 (of the clamping device 5, respectively the conveying separating device 6) are given by 59, respectively 69.

It can be seen clearly that the clamping device 5 is more eccentric than the position of the conveying separating device 6. Between the situation in position I and III there is a 180°-rotation of the shaft 72.

In the position indicated by I the clamping device 5 is in the upper dead center. The conveying separating device 6 leads the clamping device by 45°. This leads to the fact that the conveying separating device 6 provides, first of all, a separation of the conveying unit from the engagement on the work piece 2, respectively the work piece carrier 3, the clamping device 5 lagging this movement at first.

In the position II the shaft has already rotated around 135°. The connecting rod 64 of the conveying separating device is in its lower dead center. This means that the rollers 40 have their maximal distance from the work piece carrier 3, respectively the work piece 2. In each case they are no more engaged to the work piece 2, respectively the work piece carrier 3.

At this time the work piece carrier 3, respectively the work piece 2, is already deposited on the support surfaces of the clamping device 5, and the clamping iron 53 has already started clamping the work piece 2/work piece carrier 3.

The clamping process is finished in position III. The connecting rod 54 of the clamping device 5 is in its lower dead center, the clamping forces are in full activity. The connecting rod 64 may have passed the lower dead center a bit, however, this is not a problem as the lifting movement is dimensioned accordingly so that in any case there is no engaging of the conveying device to the work piece 2/work piece carrier 3.

The shaft 72 is held so long in the position indicated with III until the machining has been finished. After that the arrangement is released again, in this case the shaft 72 rotates back anticlockwise and, first of all, the clamping device 5 is discharged, and, after that, the conveying separating device 6 is deactivated, engaging again the conveying unit 4 with the work piece 2/work piece carrier 3.

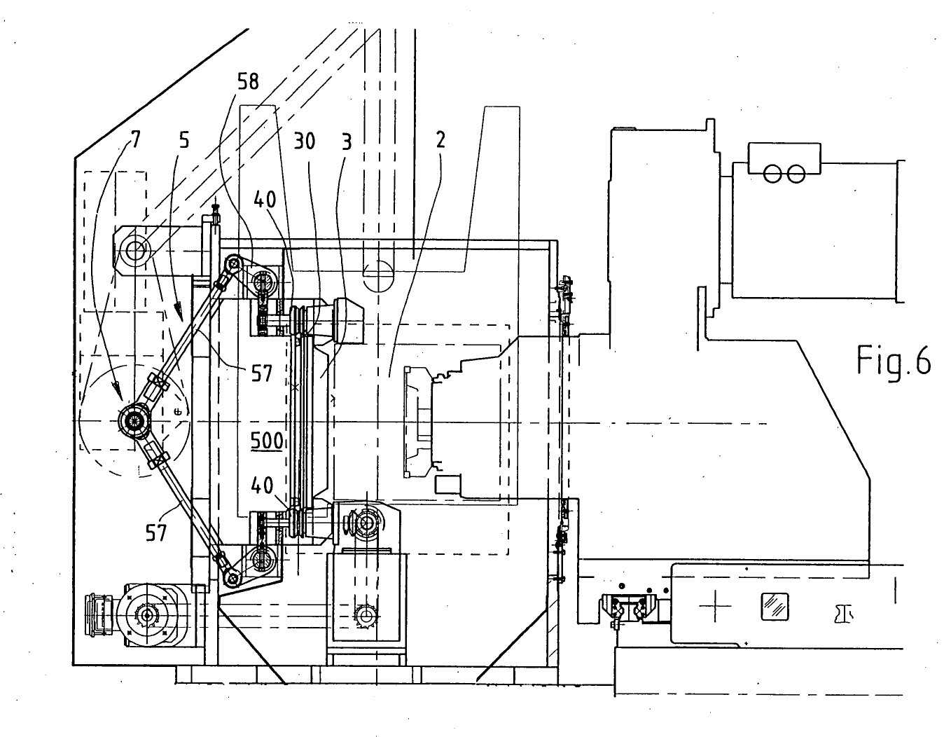

In FIG. 6 another variant according to the invention is shown. It can basically be compared with the embodiment according to FIG. 3, because here also an upright arrangement of the work piece carrier 3 has been chosen. However, the roller 40 is designed here V-shaped or groove-like, causing a lateral guide for the work piece carrier 3 by means of the roller 40. The rollers 40 are here axially supported on springs in order to follow the clamping movement which is imprinted by the central drive 7 and the clamping device 5. Via the control rod 57 a force is imprinted on the knuckle joint 58 in order to achieve a clamping movement to the right hand side. The arrangement is designed here symmetric around a center plane in order to achieve by the symmetric arrangement of the two control rods 57 and the knuckle joints 58 an even impingement of forces on the clamping slab 500. During the clamping movement the clamping slab 500 is shifted to the right hand side and the indexes lead to an exact positioning at the desired point. For that purpose the work piece carrier 3 has cone-like receivers 30. As during the clamping movement the pallet 3 is shifted to the right hand side the rollers 40 are supported axially flexibly and can move against spring assemblies in order to be able to follow the clamping movement.

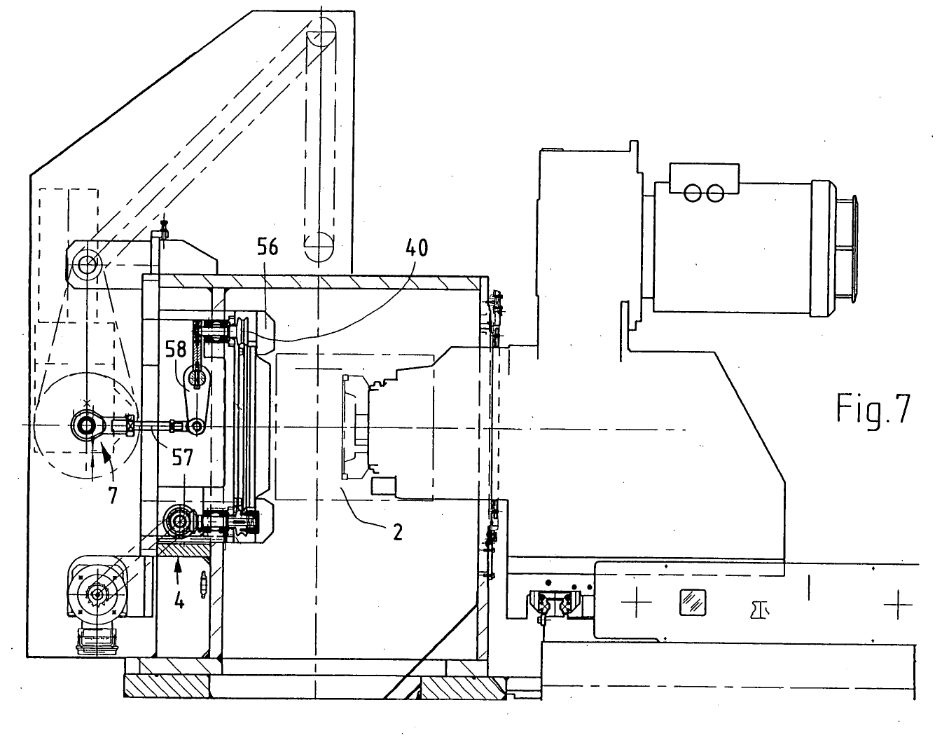

The embodiment according to FIG. 7 is basically similar to the one in FIG. 6. In the bottom region the conveying device 4 is indicated, which drives the rollers 40 (below). Here also groove-like, V-shaped, if necessary even crowned, drive rollers 40 are provided. The crowned embodiment leads to a point or linear contact and therefore to a low wear in the rollers 40. In the variant shown here stationary clamping surfaces 56 are provided against which the work piece carrier 3 is clamped. Again the clamping force is imprinted by the control rod 57 and the knuckle joint 58, and the clamping movement is carried out to the right hand side. In order to allow an axial shifting of the roller 40 there is either the possibility that the shaft co-moves or the shaft is fixed and the roller is axially movable against the force of the springs. In order to design the shaft flexibly, for example, a sleeve or a liner is provided which leads the shaft axially.

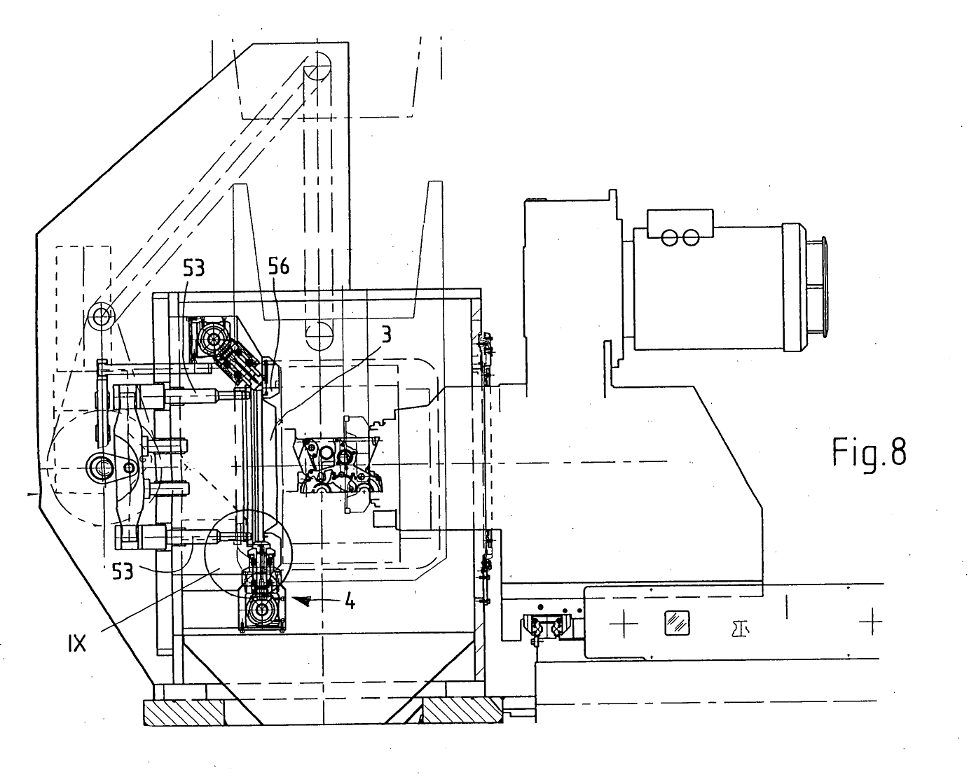

In FIG. 8 also an embodiment is shown which can be compared with the FIGS. 6 and 7.

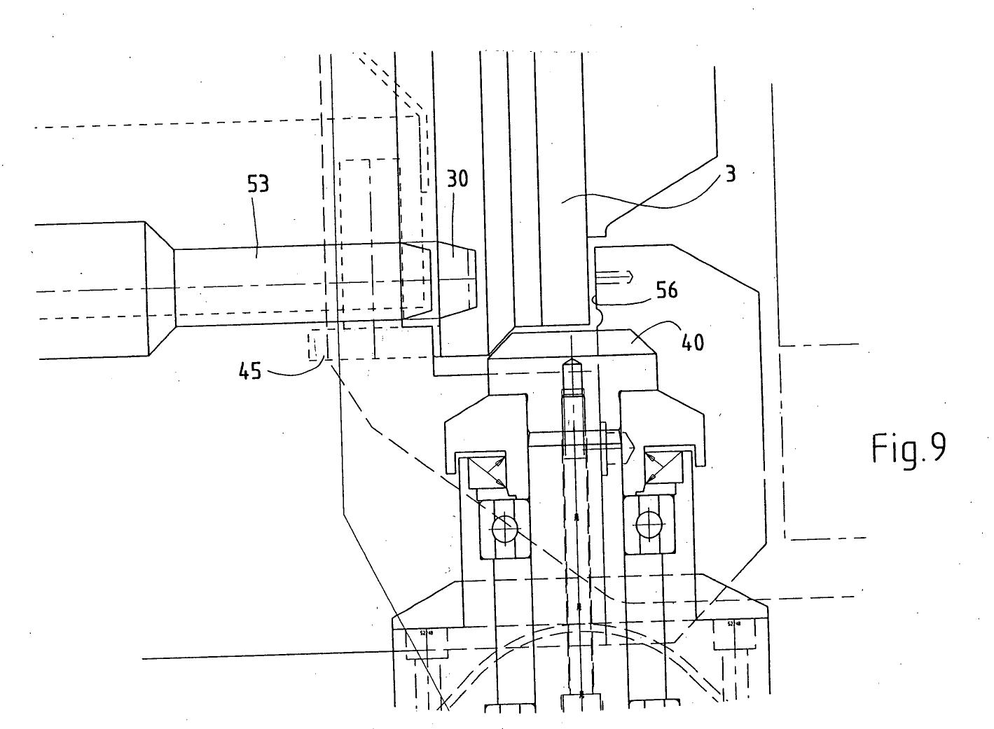

In FIG. 9 the detail IX according to FIG. 8 is enlarged and therefore shown more clearly. In FIG. 9 it is indicated that truncated cone-like rollers 40 are used. The contact surface to the pallet 3 is therefore orientated inclined. The rotational axis of the roller 40 is orientated vertically. In order to prevent the pallet from slipping to the left hand side support rollers 45 are arranged on the left hand side next to the pallet 3 which also rotate around a vertical axis. The rollers 45 are here designed like cylinders with vertically orientated surfaces.

Here the drive 7 acts on the clamping die 53, the clamping direction goes to the right hand side. The conical front region engages as clamping cone into a cone-like recess 30 in the work piece carrier, respectively the pallet 3. By means of that the work piece carrier 3 is pressed against the clamping surface 56, the complete bearing of the roller can also follow this movement.

Basically, of course, the clamping movement is possible also vice versa, namely, in that way that the clamping cone is stationary and the clamping iron is moved, which would shift the pallet in the example shown in FIG. 8 to the left and thus clamp it. In this case only the support rollers 45 should be designed in such a way that the could recede.

Although the invention has been described by exact examples which are illustrated in the most extensive detail, it is pointed out that this serves only for illustration and that the invention is not necessarily limited to it because alternative embodiments and methods become clear for experts in view of the disclosure. Accordingly changes can be considered which can be made without departing from the contents of the described invention.

1. Machine tool where the work piece is conveyed by means of a conveying device in the working area of the machine tool, and the work piece, respectively a work piece carrier carrying the work piece, is clamped by a clamping device in the machining position, characterised in that the conveying device (4) provides the feeding as well as the removing of the work piece (2) to and from the machine tool. (1), in particular from and to adjoining machine tools, as well as the conveying of the work piece (2) in the working area (16).

2. Machine tool according to claim 1, characterised in that the conveying device conveys the work piece, respectively a work piece carrier carrying the work piece, directly in the clamping device.

3. Machine tool according to claim 1, characterised in that the working area (16) can be sealed by at least one door (10) which can be moved horizontally or vertically.

4. Machine tool according to claim 1, characterised in that a drive (7) is provided which is designed as common drive (7) for the clamping device (5) and for a conveying separating device (6), and the conveying separating device (6) provides that the conveying device (4) during clamping of the work piece (2) does not try to convey the work piece (2) and makes it possible that the clamping device clamps the work piece.

5. Machine tool according to claim 1, characterised in that a drive (7) is provided which is designed as a common drive (7) for the clamping device (5) and a conveying separating device, and after the work piece (2) has been conveyed in the working area (16), first of all the drive (7) acts on the conveying separating device (6) and, after that, the drive (7) acts on the clamping device (5).

6. Machine tool according to claim 1, characterised in that, while the clamping device (5) clamps the work piece, respectively a work piece carrier carrying the work piece, the conveying device does not move the work piece.

7. Machine tool according to claim 1, characterised in that a drive (7) is provided which is designed as a common drive (7) for the clamping device (5) and a conveying separating device, and by a preferably mechanically designed forced control of the drive (7) of the conveying separating device (6) and the clamping device (5).

8. Machine tool according to claim 1, characterized in that a drive (7) is provided which is designed as common drive (7) for the clamping device (5) and a conveying separating device, and by a preferably mechanically designed forced control of the drive (7) for the conveying separating device (6) or the clamping device (5).

9. Machine tool according to claim 1, characterised in that a drive (7) is provided which is designed as common drive (7) for the clamping device (5) and a conveying separating device, and both the clamping device (5) and the conveying separating device. (6) have a control rod (57, 67) on which a shaft (72, 72′) driven by the drive (7) acts.

10. Machine tool according to claim 1, characterized in that a drive (7) is provided which is designed as common drive (7) for the clamping device (5) and a conveying separating device, and both the clamping device (5) and the conveying separating device (6) have a control rod (57, 67) on which acts a shaft (72, 72′) driven by the drive (7), and both the clamping device (5) and the conveying separating device (6) have a control rod (57, 67) on which acts a shaft (72, 72′) which is driven by the drive (7), and the shaft (72, 72′) acts at different angle positions on the control rod (67, 57) of the conveying separating device (6), respectively of the clamping device (5).

11. Machine tool according to claim 1, characterised in that a drive (7) is provided which is designed as common drive (7) for the clamping device (5) and a conveying separating device, and both the clamping device (5) and the conveying separating device (6) have a control rod (57, 67) on which acts a shaft (72, 72′) driven by the drive (7), and both the clamping device (5) and the conveying separating device (6) have a control rod (57, 67) on which acts a shaft (72, 72′) driven by the drive (7), and the control rod (57, 67) has a connecting rod (54, 64), and on the shaft (72, 72′) eccentrically a crank pin is arranged which is connected with the connecting rod (54, 64).

12. Machine tool according to claim 1, characterised in that a drive (7) is provided which is designed as common drive (7) for the clamping device (5) and a conveying separating device, and both the clamping device (5) and the conveying separating device (6) have a control rod (57, 67) on which acts a shaft (72, 72′) driven by the drive (7), and both the clamping device (5) and the conveying separating device (6) have a control rod (57, 67) on which acts a shaft (72, 72′) driven by the drive (7), and the shaft has cams and the cams act on the control rod.

13. Machine tool according to claim 1, characterized in that the work piece (2) is conveyed by the conveying device (4) with or without work piece carrier (3).

14. Machine tool according to claim 1, characterised in that the working area (16) can be sealed by at least one door (10) which can move horizontally or vertically, and the top edge of the door (10) is arranged slightly above the top edge of the work piece (2), respectively of a work piece carrier (3) carrying the work piece (2).

15. Machine tool according to claim 1, characterized in that the conveying device (4) has a central drive shaft (43).

16. Machine tool according to claim 1, characterized in that the conveying device (4) has a central drive shaft (43), and the drive shaft (43) is arranged outside, preferably above the door (10), respectively the region (11) of the door which is covered by the opening door (10).

17. Machine tool according to claim 1, characterized in that a drive (7) is provided which is designed as common drive for the clamping device (5) and a conveying separating device, and the common drive (7) also acts on the door (10).

18. Machine tool according to claim 1, characterized in that a drive (7) is provided which is designed as common drive for the clamping device (5) and a conveying separating device and the common drive (7) acts also on the door (10), and the drive (7) of the door (10) is carried out by forced control, in particular with the drive of the conveying separating device (6) and the clamping device (5).

19. Machine tool according to claim 1, characterized in that a drive (7) is provided which is designed as common drive for the clamping device (5) and a conveying separating device, and the common drive (7) acts also on the door (10), and the drive (7) of the door (10) is carried out by forced control, in particular with the drive of the conveying separating device (6) or of the clamping device (5).

20. Machine tool according to claim 1, characterized in that a drive (7) is provided which is designed as common drive for the clamping device (5) and a conveying separating device, and the common drive (7) acts also on the door (10), and the shafts driven by the drive (7) move the door via pulleys and toothed belts.

21. Machine tool according to claim 1, characterized in that the conveying device (4) is designed as roller conveyor.

22. Machine tool according to claim 1, characterized in that the conveying device (4) is designed as roller conveyor, and the rotational axes of the roller conveyor are orientated horizontally, vertically and diagonally.

23. Machine tool according to claim 1, characterised in that the conveying device (4) is designed as roller conveyor, and the rotational axes of the roller conveyor are orientated horizontally, vertically or diagonally.

24. Machine tool according to claim 1, characterised in that the conveying device (4) is designed as roller conveyor, and the support surfaces of the work piece carrier which interact with the rollers of the conveying device are designed horizontally, vertically or diagonally.

25. Machine tool according to claim 1, characterized in that a drive (7) is provided which is designed as common drive for the clamping device (5) and a conveying separating device, and the conveying separating device (6) is designed with regard to the work piece (2) as lowering device or lifting device.

26. Machine tool according to claim 1, characterized in that a drive (7) is provided which is designed as common drive for the clamping device (5) and a conveying separating device, and the conveying separating device (6) is designed with regard to the work piece (2) as lowering device or lifting device, and both the clamping device (5) and the conveying separating device (6) have a control rod (57, 67), on which acts a shaft (72, 72′) driven by the drive (7), and the control rod (67) of the conveying separating device (6) disengages the conveying device (4) from the work piece (2), respectively the work piece carrier (3) carrying the work piece (2).

27. Machine tool according to claim 1, characterised in that the work piece (2), respectively the work piece carrier (3) carrying the work piece (2), is supported and can be driven laterally by a row (41, 42) of rollers (40) as conveying device (4), and the rollers (40) of the first row (41) and the rollers (40) of the second row (42) are arranged on independent shafts.

28. Machine tool according to claim 1, characterised in that the work piece (2), respectively the work piece carrier (3) carrying the work piece (2) is supported and can be driven laterally by a row (41, 42) of rollers (4) as conveying device (4), and the work piece (2) is arranged between the two rows (41, 42) of rollers.

29. Machine tool according to claim 1, characterized in that the work piece (2) is clamped on the work piece carrier (3) upright or suspended, respectively the work piece (2) is conveyed, respectively machined on, upright or suspended.

30. Machine tool according to claim 1, characterised in that the work piece carrier (3) is orientated in the working area during machining in a horizontal or upright position and is conveyed in a horizontal, respectively upright, position.

31. Machine tool according to claim 1, characterized in that the work piece carrier (3) is orientated in the workinh area during machining either in a horizontal or upright position or is conveyed in a horizontal, respectively upright, position.

32. Machine tool according to claim 1, characterized in that the conveying device (4) in the working area (16) is designed in such a way that it can be moved. In particular swivelled, away from the conveying plane which conveys the work piece (2).

33. Machine tool according to claim 1, characterised in that the work piece (2), respectively the work piece carrier (3) carrying the work piece (2), is supported and can be driven laterally by a row (41, 42) of rollers (40) as conveying device (4), and the rollers (40) of the first row (41) and the rollers (40) of the second row (42) are arranged on independent shafts, and in the working area (16) at least a part of the rollers (40) of the conveying device (4) is supported rotatably around an axis (44), and the control rod (67) of a conveying separating device (6) acts on the roller (40) against the force of a pull-back spring or guided by force so that the roller (40) becomes disengaged on the work piece (2) respectively the work piece carrier (3) carrying the work piece (2).

34. Machine tool according to claim 1, characterised in that a drive (7) is provided which is designed as common drive (7) for the clamping device (5) and a conveying separating device, and each of the clamping device (5) and the conveying separating device (6) have a control rod (57, 67) on which shaft (72, 72′9 driven by the drive (7) acts, and the control rod (67) of the conveying separating device acts, guided by force, in such a way that on the roller (40) that the control rod provides that the roller (40) comes into disengagement with the work piece (2), respectively the work piece carrier (3), as well as also provides that the roller (40) comes again into engagement with the work piece (2), respectively the work piece carrier (39.

35. Machine tool according to claim 1, characterised in that the work piece (2), respectively the work piece carrier (3) carrying the work piece (2), is supported and can be driven laterally by a row (41, 42) of rollers (40) as conveying device (4), and the rollers of the conveying device can be moved axially that during clamping the work piece, respectively the work piece carrier carrying the work piece, the rollers can follow the clamping movement of the work piece, respectively the work piece carrier.

36. Machine tool according to claim 1, characterised in that the clamping device (5) has a support surface on which the work piece (2), respectively the work piece carrier (3) carrying the work piece (29, is supported in the working area (16), as soon as the conveying device (4) is not engaged anymore.

37. Machine tool according to claim 1, characterised in that the clamping device (5) has a clamping surface against which the work piece (2), respectively the work piece carrier (3) carrying the work piece (2).

38. Machine tool according to claim 1, characterised in that the work piece (2) is exactly positioned, respectively indexed, during clamping.

39. Machine tool according to claim 1, characterized in that a drive (7) is provided which is designed as common drive (7) for the clamping device (5) and a conveying separation device, and the clamping device (5) and each of the conveying separating device (6) have a control rod (57, 67) on which a shaft (72, 72′9 criven by the drive (7) acts and the control rod (57) of the clamping device (5) causes the clamping of the work piece (2).

40. Machine tool according to claim 1, characterised in that the clamping device has at least one clamping iron and the clamping iron clamps the work piece (2) against in particular stationary clamping cones (??).

41. Machine tool according to claim 1, characterised in that the clamping device has one or more clamping cones (53) which engage in the recesses of the work piece co-operating with the clamping cones or in the work piece carrier carrying the work piece and clamp it against a support.

42. Machine tool according to claim 1, characterized on that the clamping movement of the work piece, respectively the work piece carrier carrying the work piece, is carried out by the clamping device vertically, horizontally or diagonally.

43. Machine tool according to claim 1, characterized in that the work piece (2) respectively the work piece carrier (3) is clamped by at least two times two clamping irons and the clamping irons are put on preferably in the corner regions of the work piece (2), respectively the work piece carrier.

44. Machine tool according to claim 1, characterised in that the clamping device has one or more clamping cones (53) which engage in the recesses of the work piece which interact with the clamping cones or in the work piece carrier carrying the work piece, and clamped it against a support, and a clamping crosshead (50) is provided which extends essentially parallel to the work piece (2), respectively the work piece carrier (3), and the crosshead (50) moves the clamping irons or the clamping cones (53).

45. Machine tool according to claim 1, characterised in that a drive (7) is provided which is designed as common drive (7) for the clamping device (5) and a conveying separating device, and each of the clamping device (5) and the conveying separating device (6) has a control rod (57, 67) on which a shaft (72, 72′) acts which is driven by the drive (7), and the clamping device has one or more movable clamping cones (53) which engage in the recesses of the work piece or of the work piece carrier carrying the work piece which interact with the clamping cones, and clamp it against a support, and a clamping crosshead 850) is provided which extends essentially parallel to the work piece (2), respectively to the work piece carrier (3), and the crosshead (50) moves the clamping iron or the clamping cones (53) and the control rod (57) acts on the clamping traverse (50).

46. Machine tool according to claim 1, characterised in that a drive (7) is provided which is designed as common drive (7) for the clamping device (5) and a conveying separating device, and each of the clamping devcice (5) and the conveying separating device (6) has a control rod (57, 67) on which a shaft (72, 72′) acts which is driven by the drive (7), and the clamping device has one or more clamping cones (53) which engage in the recesses of the work piece or the work piece carrier carrying the work piece and interact with the clamping cones, and clamps it against a support, and a clamping crosshead (50) is provided which extends essentially parallel to the work piece (2) respectively the work piece carrier (3), and the clamping crosshead (50) is supported flexibly (51) on the control rod (57).

47. Machine tool according to claim 1, characterised in that a drive (7) is provided, and the drive (7) has a gear (71).

48. Machine tool according to claim 1, characterised in that a drive (7) is provided, and the drive (7) has two drive shafts (72, 72′), and the drive (7) is arranged between the roller rows (41, 42).

49. Machine tool according to claim 1, characterised in that a drive (7) is provided, and the drive (7) has two drive shafts (72, 72′), and the drive (7) is arranged between the roller rows (41, 42) and each drive shaft (72, 72′) acts as shaft (72, 72′) on the control rods (57, 67).

50. Machine tool according to claim 1, characterised in that a drive (7) is provided and the drive (7) is equipped as cyclic magnet, servo-motor or gear motor.

51. Machine tool according to claim 1, characterised in that a drive (7) is provided, and the drive (7) is designed hydraulically or pneumatically.

52. Machine tool according to claim 1, characterised in that a drive (7) is provided which is designed as common drive (7) for the clamping device (5) and a conveying separating device, and each of the clamping device (5) and the conveying separating device (6) have a control rod (57, 67) on which a shaft (72, 72′9 driven by the drive (7) acts, and the control rod (67) of the conveying separating device (6) lifts at least the rollers (40) of the conveying device (4) from the work piece (2) respectively the work piece carrier (3) carrying the work piece (2), deposits the work piece (2), respectively the work piece carrier (3) carrying the work piece (2), on the support surface of the clamping device (5), and after that the control rod (57) of the clamping device (5) causes a clamping of the work piece (2), respectively the work piece carrier (3) carrying the work piece (2), against a clamping surface.

53. Machine tool according to claim 1, characterised in that in the machine tool (1) a chip collector (80) is arranged which is formed like a funnel and consists preferably of several parts (82, 83).

54. Machine tool according to claim 1, characterised in that in the machine tool (1) a chip collector (80) is arranged which is formed like a funnel and consists preferably of several parts (82, 83), and rubber bearings (81) are provided in order to fasten the chip collector (80) on the machine tool.

55. Machine tool according to claim 1, characterised in that the machine tool (1) is designed as cutting, forming, assembling or separating machine or the machine tool (1) is designed as testing station, mounting station, adjustment station, surface treatment station, indication station or cleaning station.

56. Machine tool according to claim 1, characterised by a clamping device (5) with one or more movable clamping cones (53) and a conveying device 84) designed as a roller conveyor, which has rollers (40), and air or cleaning liquid jets for the running treads of the rollers and the clamping cones.

57. Machine tool according to claim 1, characterised by a clamping device (5) with one or more clamping cones (53) and a conveying device (4) designed as a roller conveyor which has rollers (40) and air jets or cleaning liquid jets for the running treads of the rollers or the clamping cones.
